(19) United States
(12) Patent Application Publication
(10) Pub. No.: US 2007/0257157 A1
(43) Pub. Date: Nov. 8, 2007

(54) Frame structure for holding a helical hose assembly

(76) Inventor: Chao-Hui Lu, Hsin Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/415,216

(22) Filed: May 2, 2006

(51) Int. Cl. F16L 3/22

(52) U.S. Cl. 248/68.1; 248/65; 248/220.41; 248/250

(57) ABSTRACT

A frame structure for the helical hose holding assembly includes a mainframe having at least one hooking portion and at least one locking hole. The hooking portions of the mainframe are easily hooked at holes of the supporting frame, and the locking holes are used to lock a joint component at the frame structure. A helical hose assembly is positioned at the supporting surface of the frame structure by the joint component. Thus, it is easy to assemble the mainframe and to assemble and disassemble the helical hose assembly one by one.

### BACKGROUND OF THE INVENTION

1. Field of the Invention

The present invention relates to a frame structure for holding a helical hose assembly, and in particular to a frame structure that holds the helical hose in a stable position.

2. Description of Related Art

A photosynthetic reactor that is composed of a helical hose assembly includes a plurality of joint components, a plurality of frame structures and a supporting frame. The helical hose assembly includes a plurality of straight hoses and a plurality of bent hoses. The straight hoses and the bent hoses are separately positioned and connected in parallel.

In the prior art, each frame structure for holding helical hoses includes U-shaped holding rods and two bolts. When the helical hoses are positioned on the supporting frame, the U-shaped holding rods are positioned in the vicinity of the helical hoses and threads through the supporting frame. The two bolts are respectively used to hold two ends of the U-shaped holding rods so that the helical hoses are fixed upon the supporting frame.

Because the helical hoses are heavy and bulky, they are not easily assembled or disassembled. Thus, they are easily damaged. If the helical hoses are positioned upon the supporting frame one by one, then the helical hoses are likely to become misaligned. Thus, the stability of the helical hoses is inadequate, and liquid or fluid stored within the helical hoses will likely leak.

Thus, there is a need for a frame structure for holding the helical hose assembly in a stable position.

### SUMMARY OF THE INVENTION

It is an object of the present invention to provide a frame structure for holding a helical hose assembly that is used to hold a photosynthetic reactor that is easily assembled and disassembled.

It is another object of the present invention to provide a frame structure for holding a helical hose assembly that can be fine-tuned so that the hose assembly can be firmly held.

To achieve the objects of the present invention, the present invention provides a frame structure for a holding helical hose assembly. The frame structure includes a mainframe having at least one hooking portion and at least one locking hole. The mainframe also includes a holding surface and a supporting surface. The holding surface is longitudinally positioned along the mainframe, and the supporting surface is positioned traverse to the mainframe. The hooking portions are positioned at the holding surface and are inverted L-shaped. The locking holes are positioned below the supporting surface.

The mainframe is easily hooked at holes of the mainframe by the hooking portions, and the locking holes are used to lock a joint component at the mainframe. A helical hose assembly is positioned at the supporting surface of the mainframe by the joint component. Thus, it is easy to assemble the mainframe and to assemble and disassemble the helical hose assembly one by one.

The present invention also provides another embodiment, and the locking holes are extended along the mainframe so that an elongated hole is formed. Thus, a bolt extends through the locking holes and can be fine-tuned so that the helical hose assembly is firmly positioned at the mainframe.

### BRIEF DESCRIPTION OF THE DRAWINGS

The present invention can be fully understood from the following detailed description and preferred embodiments with reference to the accompanying drawings, in which:

FIG. 1 is a perspective view of a frame structure for the helical hose holding assembly according to the present invention;

FIG. 2 is a side elevated view of the first embodiment of the frame structure for the helical hose holding assembly of a photosynthetic reactor according to the present invention;

FIG. 3 is a perspective view of the first embodiment of the frame structure for the helical hose holding assembly of a photosynthetic reactor according to the present invention;

FIG. 4 is a perspective view of a frame structure for the helical hose holding assembly of the present invention that is used to position the helical hose assembly by hooking the supporting frame of the photosynthetic reactor;

FIG. 5 is a perspective view of the second embodiment of the frame structure for the helical hose holding assembly according to the present invention;

FIG. 6 is a side-elevated view of the second embodiment of the frame structure for the helical hose holding assembly of a photosynthetic reactor according to the present invention;

FIG. 7 is a perspective view of the second embodiment of the frame structure for holding a photosynthetic reactor according to the present invention; and

FIG. 8 is a perspective view of the third embodiment of a frame structure for the helical hose holding assembly according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

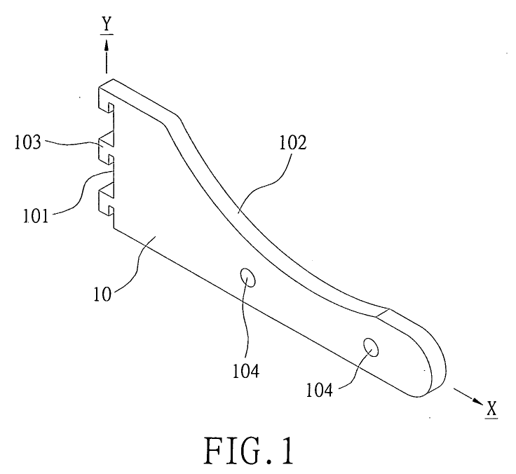

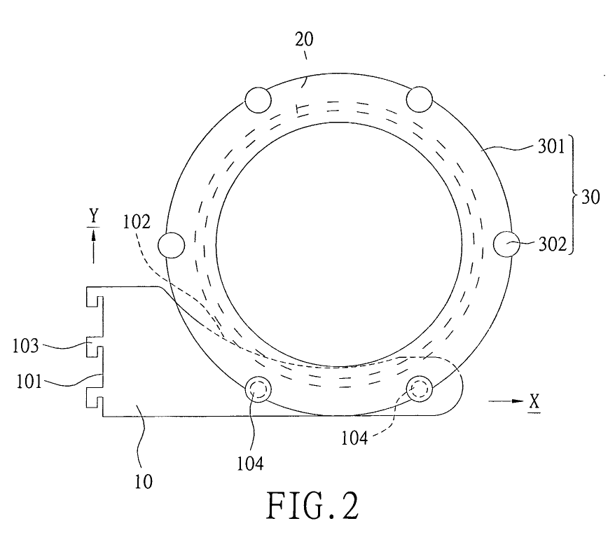

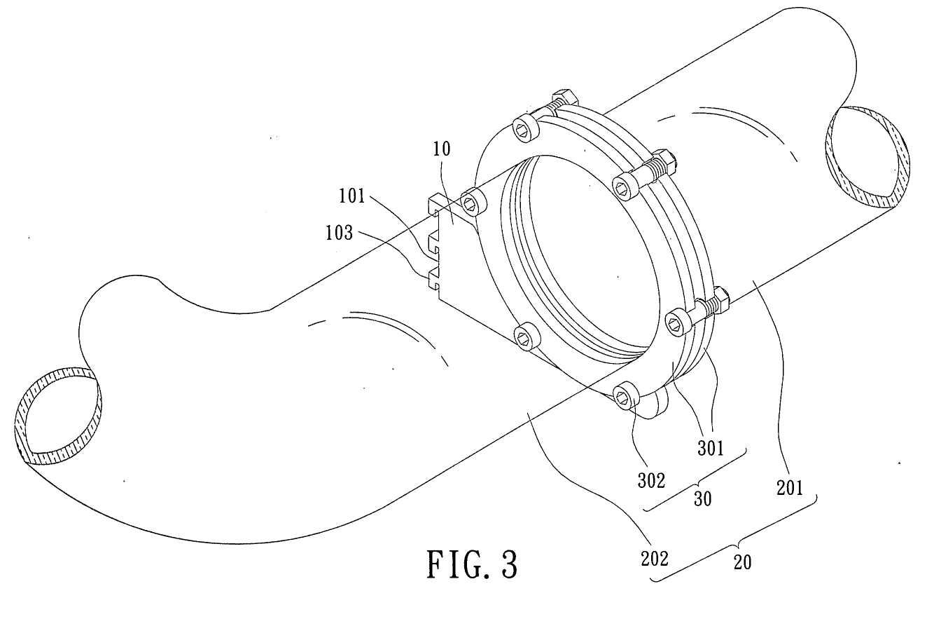

Reference is made to FIG. 1. FIG. 1 illustrates the first embodiment of the frame structure for helical hose holding assembly according to the present invention. The present invention includes a mainframe 10 having a holding surface 101, a supporting surface 102, at least one hooking portion 103 and at least one locking hole 104. The mainframe 10 is metallic and made via a punching process or is plastic and made via an injection molding process. The holding surface 101 is integrally formed with the mainframe 10 and positioned along the direction of arrow Y. The supporting surface 102 is integrally formed with a mainframe 10 and substantially positioned along the direction of arrow X. According to the first embodiment of the present invention, the supporting surface 102 has a concave curve to comply with the periphery of a hose (as shown in FIGS. 2 and 3).

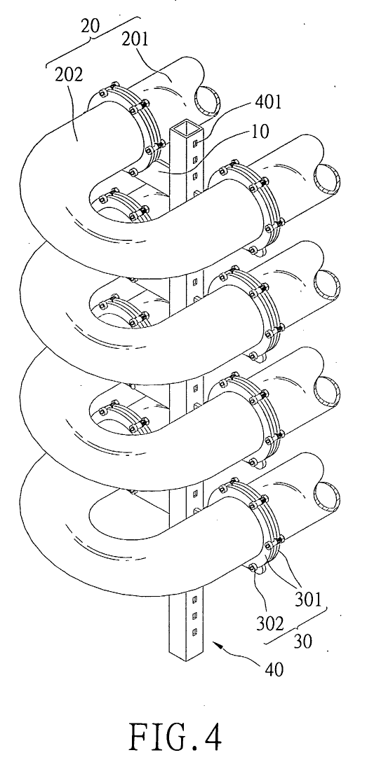

At least one hooking portion 103 is positioned at and integrally formed with the holding surface 101. According to the first embodiment of the present invention, the hooking portions 103 are inverted L-shaped to hook upon a supporting frame 40 (as shown in FIG. 4).

At least one locking hole 104 is positioned near the bottom of the supporting surface 102. According to the first embodiment of the present invention, there are two locking holes 104 in the mainframe 10. In addition, the two locking holes 104 are positioned upon the mainframe 10 and along the direction of arrow X.

Reference is made to FIGS. 1-4. The mainframe 10 is applied to a photosynthetic reactor including a helical hose assembly 20, a plurality of joint components 30, a plurality of mainframes 10 and a supporting frame 40. A plurality of holes 401 are positioned at both sides of the supporting frame 40 and are used to receive the hooking portions 103 of the holding surface 101 of the mainframe 10. Thus, the mainframes 10 are positioned within the both sides of the supporting frame 40. The helical hose assembly 20 includes a plurality of straight hoses 201 and a plurality of bent hoses 202, and the straight hoses 201 and the bent hoses 202 are connected and sealed by the joint components 30 and the supporting surfaces 102 of the mainframes 10. Each joint component 30 includes two fixing pieces 301 and a plurality of bolts 302. Two fixing pieces 301 of each joint component 30 are overlapped and used to hold ends of the straight hose 201 and the bent hoses 202. Because two bolts 302 are threaded through two screw holes 104 of the fixing pieces 301 and the mainframe 10, the ends of the straight hoses 201 and the bent hoses 202 are positioned at the corresponding mainframe 10 so that the helical hose assembly 20 is formed and is used to deliver cultivation liquid to feeding fungi and microorganism. In addition, the hooking portions 103 of the holding surfaces 101 are easily hooked at the holes 401, so it is easy to assemble the mainframe 10. The helical hose assembly 20 is positioned at the corresponding mainframe 10 by the joint component 30 one by one so that it is easy to assemble the corresponding mainframe 10 and the corresponding helical hose assembly 20.

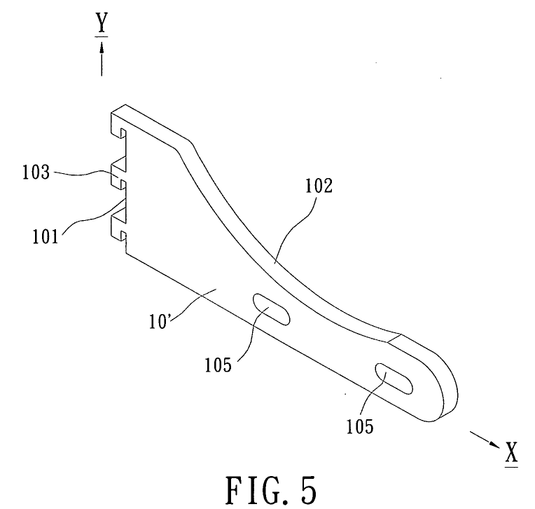

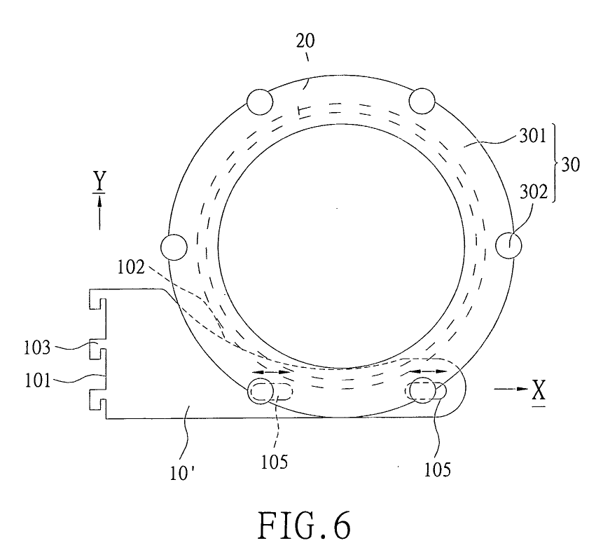

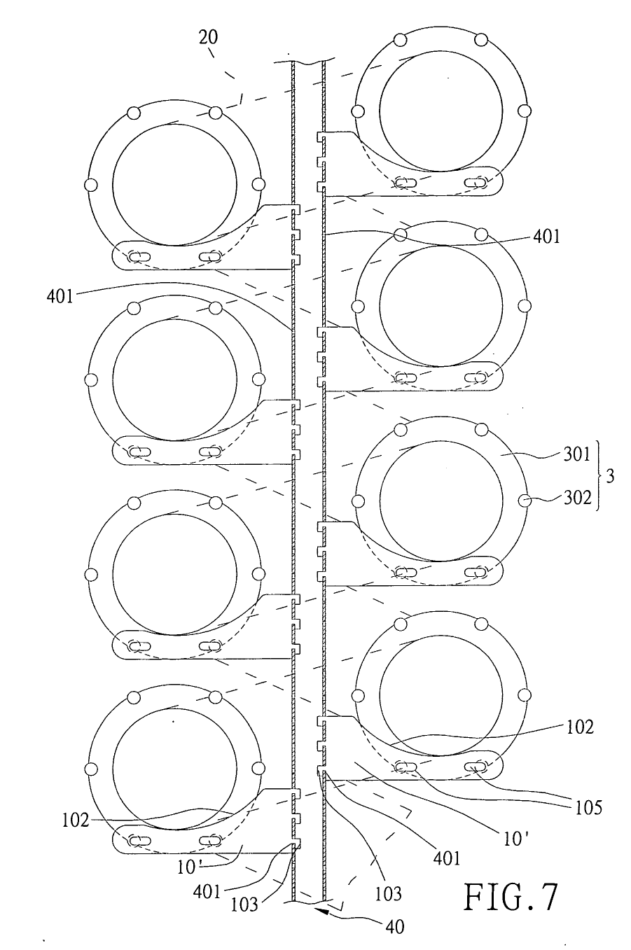

Reference is made to FIG. 5. FIG. 5 illustrates the second embodiment of the frame structure for the helical hose holding assembly of the present invention. A distinctive difference between the first embodiment and the second embodiment is that locking hole 105 of the mainframe 10′ extends along the direction of arrow X and is an elongated hole. Reference is made to FIGS. 5-7. As described above, because the locking holes 105 of the mainframes 10′ are elongated holes and the bolts 302 of the joint component 30 are threaded through the locking holes 105 of the mainframes 10′, the straight hoses 201 and the bent hoses 202 (as shown in FIG. 3) can be fine-tuned. Thus, the helical hose assembly 20 is firmly positioned at the mainframe 10′ to prevent cultivation liquid from leaking.

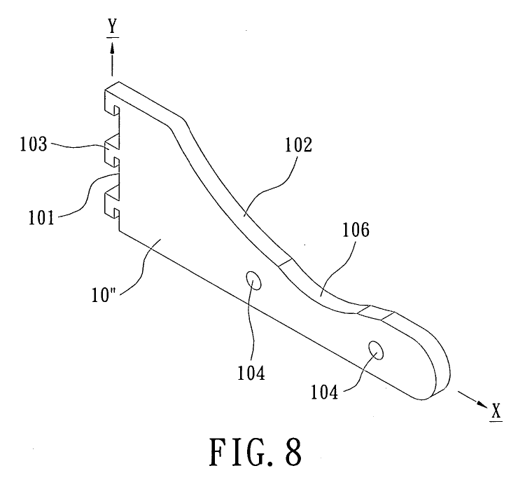

Reference is made to FIG. 8. FIG. 8 illustrates the third embodiment of the frame structure for hose holding assembly of the present invention. A distinctive difference between the first embodiment and the third embodiment is the supporting surface 102 of the mainframes 10″. The supporting surface 102 also has an arc portion 106 having the same curvature as those of the straight hoses 201 and the bent hoses 202 of the helical hose assembly 20. In this light, the helical hose assembly 20 is firmly positioned at the mainframes 10″.

As described above, the advantages of the present invention are as follows.

1. According to the present invention, the mainframe is easily positioned upon the supporting frame by hooking the hooking portions to the holes of the supporting frame. At least one locking hole is used to lock a joint component to the mainframe. A helical hose assembly is positioned at the supporting surface of the mainframe by the joint component. Thus, it is easy to assemble the mainframe and to assemble and disassemble the helical hose assembly one by one.

2. The locking holes of the mainframe are elongated holes so that the joint components threaded through the locking holes can be fine-tuned by bolts. The helical hose assembly is firmly positioned at the mainframe to prevent it from being damaged inadvertently and prevents the cultivation liquid from leaking.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A frame structure for a holding helical hose assembly, comprising:
a mainframe, including a holding surface, a supporting surface, at least one hooking portion, and at least one locking hole,
wherein the holding surface is longitudinally positioned along the mainframe and the supporting surface is positioned traverse to the mainframe, and the hooking portions are positioned at the holding surface and are inverted L-shaped, and the locking holes are positioned below the supporting surface.

2. The frame structure for the helical hose holding assembly as claimed in claim 1, wherein the supporting surface has a concave curve.

3. The frame structure for the helical hose holding assembly as claimed in claim 1, wherein the supporting surface has an arc portion having the same curvature as those of a straight hose and a bent hose of the helical hose assembly.

4. The frame structure for the helical hose holding assembly as claimed in claim 1, wherein there are two locking holes that are longitudinally positioned along the mainframe.

5. The frame structure for the helical hose holding assembly as claimed in claim 1, wherein the locking holes are extended along the mainframe so that elongated holes are formed.

6. The frame structure for the helical hose holding assembly as claimed in claim 1, wherein a plurality of holes of the supporting frame are used to receive the hooking portions of the holding surface.
